(19) United States
(12) Patent Application Publication
(10) Pub. No.: US 2019/0040318 A1
(43) Pub. Date: Feb. 7, 2019

(54) LYOTROPIC LIQUID CRYSTAL POLYMER AND SMALL MOLECULE SOLUTIONS AND FILMS

(71) Applicant: LIGHT POLYMERS HOLDING, George Town (KY)

(72) Inventors: Valeriy Kuzmin, San Bruno, CA (US); Evgeny Morozov, Burlingame, CA (US)

(21) Appl. No.: 16/050,371

(22) Filed: Jul. 31, 2018

Related U.S. Application Data
(60) Provisional application No. 62/540,164, filed on Aug. 2, 2017.

(51) Int. Cl. C09K 19/06; C09K 19/32; G02B 5/30

(52) U.S. Cl. CPC C09K 19/066; C09K 19/322; G02B 5/3016; G02B 5/3025; G02B 5/3083

(57) ABSTRACT

A composition includes an aqueous mixture of birefringent small molecules and a birefringent polymer. The birefringent small molecules are of a structure:

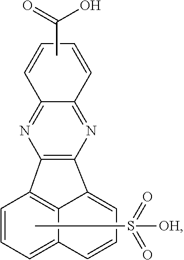

or a salt thereof.

The birefringent polymer is of a structure:

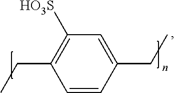

or salt thereof,
where n is an integer in a range from 25 to 10,000.

### BACKGROUND

Optically anisotropic materials are significant in modern optical applications. Many achievements in information display technologies are based on development of anisotropic optical retarder layers.

Phase retarder layers used in modern LCD technology are produced by mechanical stretching of the extruded or cast polymers. Control of optical anisotropy can be achieved by adjusting stretching parameters as well as material selection. A polymeric phase retarder layer, for example, can be attached to a PVA (polyvinyl alcohol) polarizer sandwiched between protective layers. Retarder layers can combine both optical compensation and protective functions. For example, cyclic-olefin polymers (COP) are used for manufacturing of phase retarder layers for optical compensation of vertical alignment (VA) and in-plane switching (IPS) LCD modes, while at the same time providing a protective function. However, COP based phase retarder layers as well as other hydrophobic polymeric materials have a problem of adhesion to the hydrophilic PVA layer.

### SUMMARY

The present disclosure relates to an aqueous mixture of birefringent small molecules and a birefringent polymer. This aqueous mixture may be coated onto a substrate to from a retarder layer. The retarder may exhibit a reverse or flat reverse dispersion of retardation. The retarder may form a quarter-wave plate or an achromatic quarter-wave plate.

In one aspect, a composition includes an aqueous mixture of birefringent small molecules and a birefringent polymer. The birefringent small molecules are molecules of a structure:

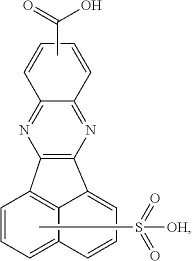

or a salt thereof.

In another aspect, a composition includes an aqueous mixture of birefringent small molecules and birefringent polymer. The birefringent small molecules are molecules of a structure:

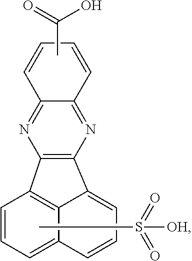

or a salt thereof; and
the birefringent polymer is a polymer of a structure:

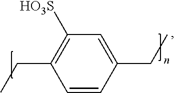

or a salt thereof; and
where n is an integer in a range from 25 to 10,000; and the birefringent polymer is present in the composition in a range from 50 to 90 wt. % dry solids, or from 60 to 80 wt. % dry solids, and the birefringent small molecules are present in the composition in a range from 50 to 10 wt. % dry solids, or from 40 to 20 wt. % dry solids.

In a further aspect, a method of forming a retarder layer includes shear coating the composition described herein onto a substrate along a shear coating direction to form an aligned aqueous layer and then drying the aligned aqueous layer to form a retarder layer.

In another aspect, a retarder layer includes birefringent small molecules and a birefringent polymer. The birefringent small molecules are molecules of a structure:

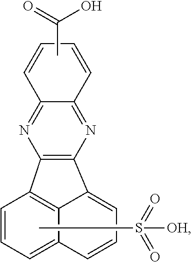

or a salt thereof; and
the birefringent polymer are polymers of a structure:

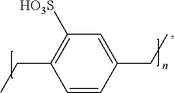

or a salt thereof,
where n is an integer in a range from 25 to 10,000.

These and various other features will be apparent from a reading of the following detailed description.

### BRIEF DESCRIPTION OF THE DRAWINGS

The disclosure may be more completely understood in consideration of the following detailed description of various embodiments of the disclosure in connection with the accompanying drawings; in which:

FIG. 1 is a schematic diagram of an illustrative single layer retarder on a substrate with a coordinate system;

FIG. 2 is a graph of illustrative normal dispersion curves of refractive indexes for each direction of the layer of FIG. 1, for visible light wavelengths for an exemplary material.

FIG. 3 is a graph of in-plane difference in refractive index Δn=(n_{y}−nₓ) of the curves of FIG. 2;

FIG. 4 is a schematic diagram of quarter-wave plate resulting from a combination of two +A plates with their slow axes (and fast axes) orthogonal to each other;

FIG. 5 is a schematic diagram of an illustrative two-layer retarder;

FIG. 6 is a schematic diagram of another illustrative two-layer retarder;

FIG. 7 is a schematic diagram of an illustrative display where the retarder is inside a liquid crystal display panel;

FIG. 8 is a schematic diagram of an illustrative display where the retarder is adjacent to the backlight;

FIG. 9 is a schematic diagram of an illustrative organic light emitting diode (“OLED”) display;

FIG. 10 is a schematic diagram of an illustrative liquid crystal display panel;

FIG. 11 illustrates a flow diagram for a method of forming a retarder described herein;

FIG. 12 is a graph illustrating the dispersion of in-plane anisotropy of a coating made of poly(monosulfo-p-xylene), sodium salt;

FIG. 13 is a graph illustrating the dispersion of in-plane retardation of a coating made of the birefringent small molecules of Example 1;

FIG. 14 is a graph illustrating the dispersion of in-plane retardation of a coating made of the birefringent small molecules and birefringent polymer composition of Example 2;

FIG. 15 is a graph illustrating the dispersion of in-plane retardation of coatings made of five of birefringent small molecule and birefringent polymer compositions of Example 3;

### DETAILED DESCRIPTION

In the following detailed description, reference is made to the accompanying drawings that form a part hereof, and in which are shown by way of illustration several specific embodiments. It is to be understood that other embodiments are contemplated and may be made without departing from the scope or spirit of the present disclosure. The following detailed description, therefore, is not to be taken in a limiting sense.

All scientific and technical terms used herein have meanings commonly used in the art unless otherwise specified. The definitions provided herein are to facilitate understanding of certain terms used frequently herein and are not meant to limit the scope of the present disclosure.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the properties sought to be obtained by those skilled in the art utilizing the teachings disclosed herein.

The recitation of numerical ranges by endpoints includes all numbers subsumed within that range (e.g. 1 to 5 includes 1, 1.5, 2, 2.75, 3, 3.80, 4, and 5) and any range within that range.

As used in this specification and the appended claims, the singular forms “a”, “an”, and “the” encompass embodiments having plural referents, unless the content clearly dictates otherwise.

As used in this specification and the appended claims, the term “or” is generally employed in its sense including “and/or” unless the content clearly dictates otherwise.

As used herein, “have”, “having”, “include”, “including”, “comprise”, “comprising” or the like are used in their open-ended sense, and generally mean “including, but not limited to”. It will be understood that “consisting essentially of”, “consisting of”, and the like are subsumed in “comprising,” and the like.

In this disclosure:

“thermally stable” refers to materials that remain substantially intact at 100 degrees Celsius;

“birefringent” refers to the optical property of a material having a refractive index that depends on the polarization and/or propagation direction of light being transmitted therethrough;

“refractive index” or “index of refraction,” refers to the absolute refractive index of a material that is understood to be the ratio of the speed of electromagnetic radiation in free space to the speed of the radiation in that material. The refractive index can be measured using known methods and is generally measured using an Abbe refractometer in the visible light region (available commercially, for example, from Fisher Instruments of Pittsburgh, Pa.). It is generally appreciated that the measured index of refraction can vary to some extent depending on the instrument;

“substantially transparent” refers to a material that transmits at least 90%, or at least 95%, or at least 98% of incident visible light excluding reflections at the interfaces (e.g., due to refractive index mismatches). Light transmittance values can be measured using ASTM methods and commercially available light transmittance instruments;

“visible light” refers to light of wavelengths in a range generally from about 400 nm to about 700 nm;

“substantially non-scattering” refers to a material that has a haze value of less than 10% or less than 5% or less than 1%; haze values can be measured using ASTM methods and commercially available haze meters from BKY Gardner Inc., USA, for example;

“achromatic” refers to color-less;

“retarder layer” refers to an optically anisotropic layer which is characterized by three principal refractive indices (nₓ, n_{y} and n_{z}), wherein two principal directions for refractive indices nₓ and n_{y} define the xy-plane coinciding with a plane of the retarder layer and one principal direction for refractive index (n_{z}) coincides with a normal line to the retarder layer;

“optically anisotropic retarder layer of positive A-type” (+A) refers to an uniaxial optical layer in which principal refractive indices nₓ, n_{y}, and n_{z} obey the following condition in the visible spectral range: n_{z}=n_{y}<nₓ;

“optically anisotropic retarder layer of negative A-type” (−A) refers to an uniaxial optical layer in which principal refractive indices nₓ, n_{y}, and n_{z} obey the following condition in the visible spectral range: n_{z}=n_{y}>nₓ.

The present disclosure relates to an aqueous mixture of birefringent small molecules and a birefringent polymer. This aqueous mixture may be coated onto a substrate to from a retarder layer. The retarder layer may exhibit a reverse or flat reverse dispersion of retardation. The retarder may form a quarter-wave plate or an achromatic quarter-wave plate. In many embodiments, the small molecule component and the polymer component exhibit a lyotropic liquid crystal phase. The retarder layer may exhibit an in-plane retardation that increases with increasing light wavelength. In other embodiments, the retarder layer exhibits a substantially constant in-plane retardation as a function of wavelength. The retarder layer may be a thermally stable film that can be substantially transparent and substantially non-scattering. While the present disclosure is not so limited, an appreciation of various aspects of the disclosure will be gained through a discussion of the examples provided below.

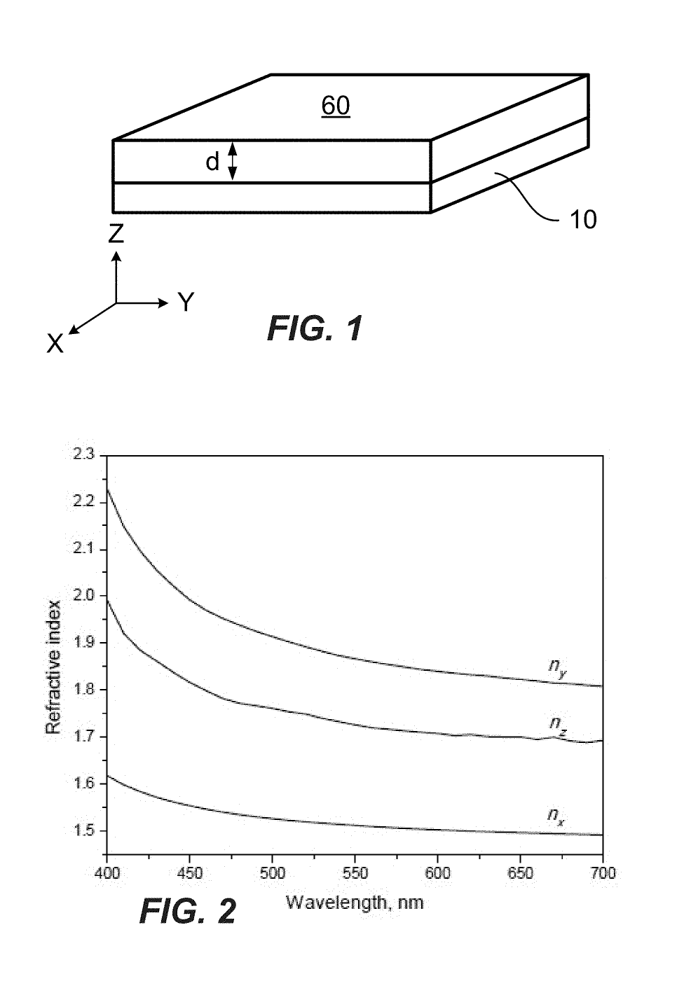

Birefringence described herein refers to macroscopic birefringence. For example, coating the birefringent polymer and birefringent small molecules (described herein) by any type of shear coating can align the molecules in more or less or primarily the same direction over a macroscopic dimension and exhibit a macroscopic birefringence. Birefringence can be characterized by measuring a refractive index of the three principal refractive indices (nₓ, n_{y} and n_{z}) associated with the Cartesian coordinate system related to the deposited birefringent polymer and/or small molecule layer or the corresponding major surface of the retarder film or plate. Two principal directions for refractive indices nₓ and n_{y} define the xy-plane coinciding with a plane of the retarder, while one principal direction for refractive index (n_{z}) coincides with a normal line to the retarder, as illustrated in FIG. 1.

An anisotropic film or coating has both a fast axis and a slow axis. An in-plane fast axis is defined by the axis corresponding to the refractive index nₓ or n_{y}, whichever is smaller. The in-plane slow axis is defined by the axis corresponding to the refractive index nₓ or n_{y}, whichever is larger.

A quarter-wave plate is an optical element providing π/2 phase shift between principal light components that have polarizations orthogonal to each other. It means that in-plane retardation of the plate is equal to ¼ of the wavelength. For example, at a light wavelength of 400 nm, the in-plane retardation would be equal to 100 nm.

Materials transparent to visible light exhibit normal dispersion, indicating a refractive index that decreases with increasing wavelength. A difference of in-plane indices usually results from normal dispersion. A birefringent material forms a birefringent film that has refractive indices nₓ, n_{y}, and n_{z} where nₓ and n_{y} correspond to two mutually perpendicular directions in a plane and n_{z} corresponds to the normal direction to the plane. In many embodiments, at least one of these refractive indices has a different value than the other refractive indices.

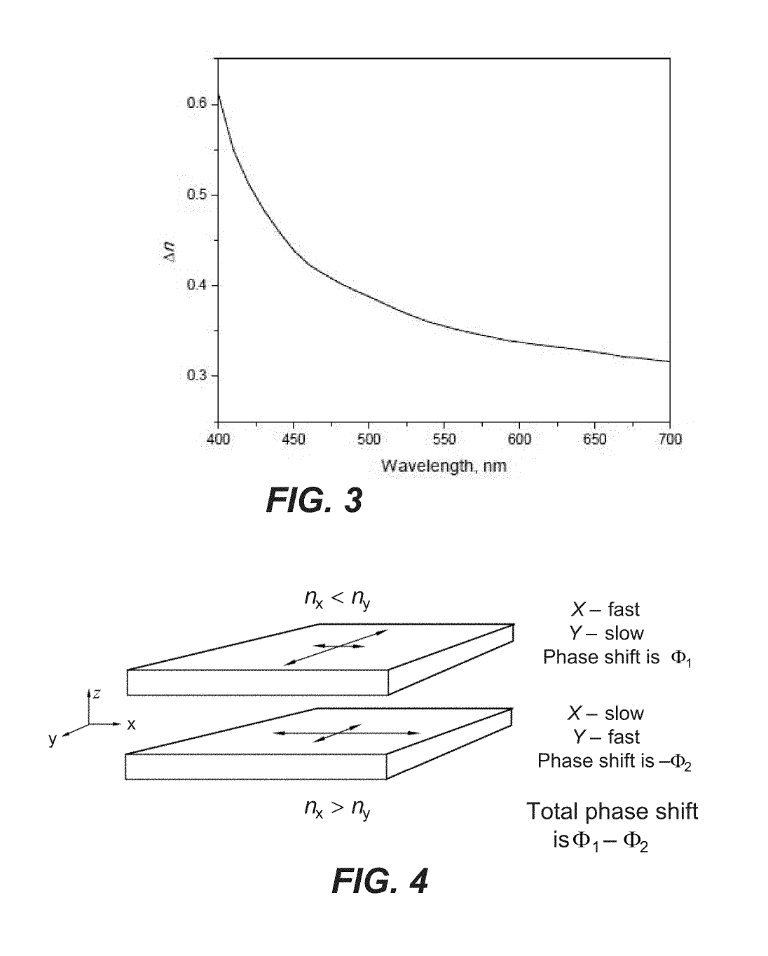

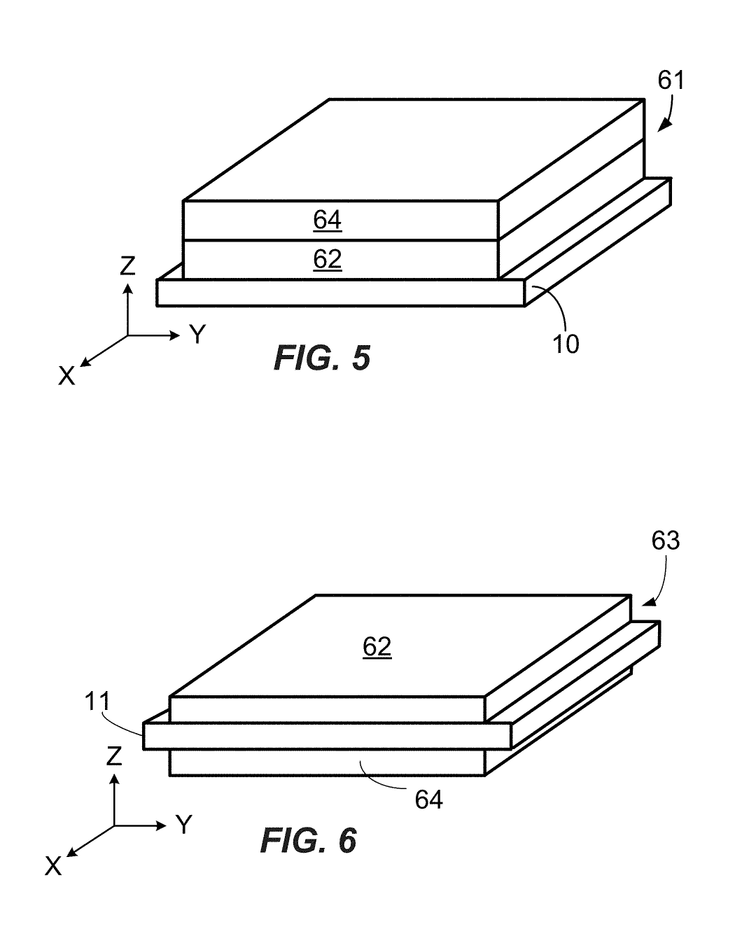

FIG. 1 illustrates this coordinate system for a retarder 60 having a thickness d. FIG. 2 illustrates normal dispersion curves (where refractive index decreases with increasing wavelength). In-plane retardation R₀ is equal to the difference in refractive index (Δn) multiplied by the thickness of the film (d). Here in-plane difference in refractive index Δn=(n_{y}−nₓ) is illustrated in FIG. 3. Thus, a retarder layer or quarter-wave plate (QWP) made of a material having normal dispersion does not compensate all the wavelengths equally well. This problem may be solved when two +A plates are stacked such that their fast axes (or slow axes) are orthogonal resulting in a combination that is illustrated in FIG. 4.

FIG. 1 is a schematic diagram of an illustrative single layer retarder 60. The retarder layer 60 can be disposed or coated onto a substrate 10. In many embodiments, the substrate 10 is optically isotropic. In other embodiments, the substrate 10 is optically anisotropic. In some embodiments, the retarder layer 60 is on a release layer of the substrate 10. In many of these embodiments, the retarder layer 60 (which has been formed on a release layer of the substrate 10) can be laminated onto an optical element, forming a laminated optical element, and then the substrate 10 can be released or cleanly removed from the retarder layer 60.

In some embodiments, the substrate 10 has an optical function and the resulting single layer retarder 60 can be referred to as a multifunctional optical film. In some of these embodiments the substrate 10 is an optical element such as a polarizer, diffuser or prism film.

In many embodiments, the retarder layer 60 is a layer comprising a mixture of birefringent small molecules and a birefringent polymer. The birefringent polymers have an in-plane slow axis primarily in a first direction and the birefringent small molecules having an in-plane slow axis substantially orthogonal to the first direction. In many of these embodiments the substrate is isotropic.

The phrase “birefringent small molecules” refers throughout the specification to a population or plurality of birefringent small molecules. This population can include small molecules that are isomers, or have primarily the same chemical structure or primarily two or more different chemical structures, or three or more different chemical structures. In some embodiments, a population that has two or more different chemical structures of the birefringent small molecules can provide more uniform alignment properties to the overall population of birefringent small molecules.

The phrase “birefringent polymer” refers throughout the specification to a population or plurality of birefringent polymers. This population can include polymers that have primarily the same chemical backbone or the same polymer structure or primarily two or more isomers or different chemical backbones or structures, or primarily three or more isomers or different chemical backbones or structures.

In many embodiments, this single layer retarder 60 exhibits an in-plane retardation that increases as a function of wavelength in a wavelength range of 400 to 700 nanometers (reversion dispersion of retardation). In other embodiments, this single layer retarder 60 exhibits in-plane retardation values that vary by +/−5% or less, or +/−3% or less, or +/−2% or less, or +/−1% or less in or over a wavelength range from 400 to 700 nanometers (flat dispersion of retardation).

The single layer retarder 60 can have a thickness of less than 25 micrometers, or less than 20 micrometers, or less than 10 micrometers, or less than 5 micrometers. In many embodiments, this single layer retarder 60 has a thickness in a range from 1 to 10 micrometers, or from 1 to 5 micrometers. In many embodiments, the retarder layer 60 is a quarter-wave plate or an achromatic quarter-wave plate.

The retarder layer 60 may be formed of a mixture of birefringent polymer and birefringent small molecules. The birefringent polymer may be present in the retarder layer in a range from 50 to 90 wt. % dry solids, or from 60 to 80 wt. % dry solids, and the birefringent small molecules are present in the retarder layer in a range from 50 to 10 wt. % dry solids, or from 40 to 20 wt. % dry solids. In some embodiments, the birefringent small molecules are present in the retarder in a range from 30 to 25 wt. % dry solids, and the birefringent polymer is present in the retarder in a range from 70 to 75 wt. % dry solids. In other embodiments, the birefringent small molecules are present in the retarder in a range from 35 to 30 wt. % dry solids, and the birefringent polymer is present in the retarder in a range from 65 to 70 wt. % dry solids.

FIG. 5 is schematic diagram of an illustrative two-layer retarder 61. FIG. 6 is a schematic diagram of another illustrative two-layer retarder 63. A first layer 62 can be a layer formed of birefringent small molecules and the second layer 64 can be formed of birefringent polymer. The birefringent polymer has an in-plane fast axis primarily in a first direction (along Y axis, for example) and the birefringent small molecules have an in-plane fast axis substantially orthogonal to the first direction (along X axis, for example).

In many embodiments, this two-layer retarder 61, 63 exhibits an in-plane retardation that increases as a function of wavelength in a wavelength range of 400 to 700 nanometers (reversion dispersion of retardation). In other embodiments, this two-layer retarder 61, 63 exhibits in-plane retardation values that vary by +/−5% or less, or +/−3% or less, or +/−2% or less, or +/−1% or less in or over a wavelength range from 400 to 700 nanometers (flat dispersion of retardation).

FIG. 5 illustrates the second layer 64 disposed on the first layer 62 and the first layer 62 disposed on the substrate 10. FIG. 6 illustrates the second layer 64 and the first layer 62 disposed on opposing major surfaces of the substrate 11, where the substrate 11 separates the second layer 64 and the first layer 62 from each other.

In some embodiments, the retarder 61 is on a release layer of the substrate 10. In many of these embodiments, the retarder 61 can be laminated onto an optical element, forming a laminated optical element, and then the substrate 10 can be released or cleanly removed from the retarder 61 layer.

In some embodiments, the substrate 10 has an optical function and the resulting two-layer retarder 61 can be referred to as a multifunctional optical film. In some of these embodiments the substrate 10 is an optical element such as a polarizer, diffuser or prism film.

The first layer 62 and the second layer 64 can be disposed or coated onto a substrate 10, 11. In many embodiments, the substrate 10, 11 is optically isotropic. In other embodiments, the substrate 10, 11 is optically anisotropic. In some embodiments the substrate 10, 11 is an optical element such as a polarizer.

The two-layer retarder 61 may have a total thickness of less than 25 micrometers, or less than 20 micrometers, or less than 10 micrometers, or less than 5 micrometers. In many embodiments, this two-layer retarder 61 has a thickness in a range from 1 to 10 micrometers, or from 1 to 5 micrometers. In many embodiments, the retarder 61 is a quarter-wave plate or an achromatic quarter-wave plate. The thickness of the first layer 62 and the second layer 64 can be determined based on the desired optical property of the two-layer retarder 61. In many embodiments the layers can have a thickness ratio of first layer:second layer in a range from 90:10 to 10:90.

The two-layer retarder 61 can be formed by shear coating a first layer of aqueous birefringent polymers or birefringent small molecules onto the substrate 10 to form an aligned aqueous layer. Then the aligned aqueous layer is dried to form a first layer 62. Since the first layer 62 is formed of water-soluble material, it can be stabilized or passivated by ion exchange. The first layer 62 can be thermally stable, substantially transparent and substantially non-scattering. Then the second layer of aqueous birefringent polymers or birefringent small molecules is shear coated onto the first layer 62 to form an aligned aqueous layer. Then the aligned aqueous layer is dried to form a second layer 64. Since the second layer 64 is formed of water-soluble material, it can be stabilized or passivated by ion exchange. The second layer 64 can be thermally stable that can be substantially transparent and substantially non-scattering.

Retarder layers described herein can be formed by shear coating the aqueous composition of birefringent polymer and birefringent small molecules onto the substrate 10 to form an aligned aqueous layer. Shear coating methods include slot coating, die coating, gravure coating, and the like. In many embodiments, the coating or machine direction is referred to as the X axis. In many of these embodiments the small molecule fast axis is parallel to the X axis and the polymer fast axis is orthogonal (and in-plane) to the X axis (or parallel to the Y axis), likewise the polymer slow axis is parallel to the X axis (coating or machine direction) and the small molecule slow axis is substantially orthogonal (and in-plane) to the X axis (or parallel to the Y axis).

The two-layer retarder 63 can be formed by simultaneously shear coating the aqueous birefringent polymer onto one side of the substrate 11 and the aqueous birefringent small molecule onto an opposing side of the substrate 11. Then both coated sides are dried and optionally passivated to form the two-layer retarder 63 where the second layer 64 and the first layer 62 are disposed on opposing major surface of the substrate 11.

Each layer 62, 64 of the two-layer retarder 63 can have has a thickness in a range from 1 to 10 micrometers, or from 1 to 5 micrometers. In many embodiments, the retarder 63 is a quarter-wave plate or an achromatic quarter-wave plate. The thickness of the first layer 62 and the second layer 64 can be determined based on the desired optical property of the two-layer retarder 63. In many embodiments the layers can have a thickness ratio of first layer:second layer in a range from 90:10 to 10:90.

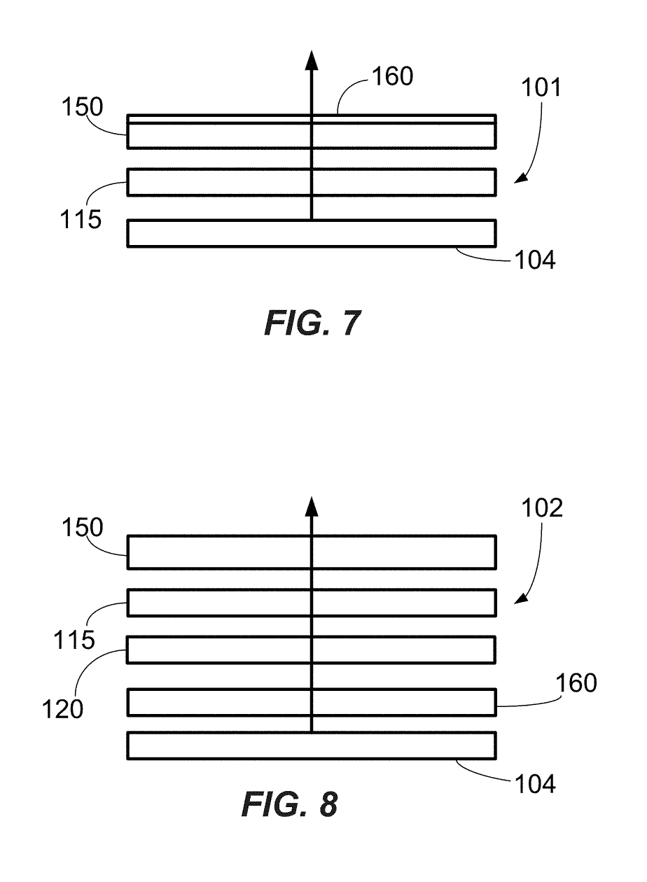

FIG. 7 is a schematic diagram of an illustrative display 101 where the retarder 160 is located at the front or light emitting face of the liquid crystal display panel 150. The display 101 includes a film stack 115 between a backlight 104 and an LCD panel 150. The film stack 115 includes one or more diffusers and one or more prism films. The retarder 160 can be disposed between the liquid crystal cell and the front polarizer (not shown) of the liquid crystal display panel 150. The arrow illustrates the general direction of light propagation from the display. Light from the backlight travels through the LCD panel 150, the retarder 160, and then the front polarizer. Therefore, the retarder 160 is optically positioned between the LCD panel 150 and the front polarizer.

FIG. 8 is a schematic diagram of an illustrative display 102 where the retarder 160 is adjacent to the backlight 104. The display 102 can include a film stack 115 between a reflective polarizer 120 and an LCD panel 150. The film stack 115 includes one or more diffusers and one or more prism films. The retarder 160 is disposed between the backlight 104 and the reflective polarizer 120. The arrow illustrates the direction of light propagation from the display.

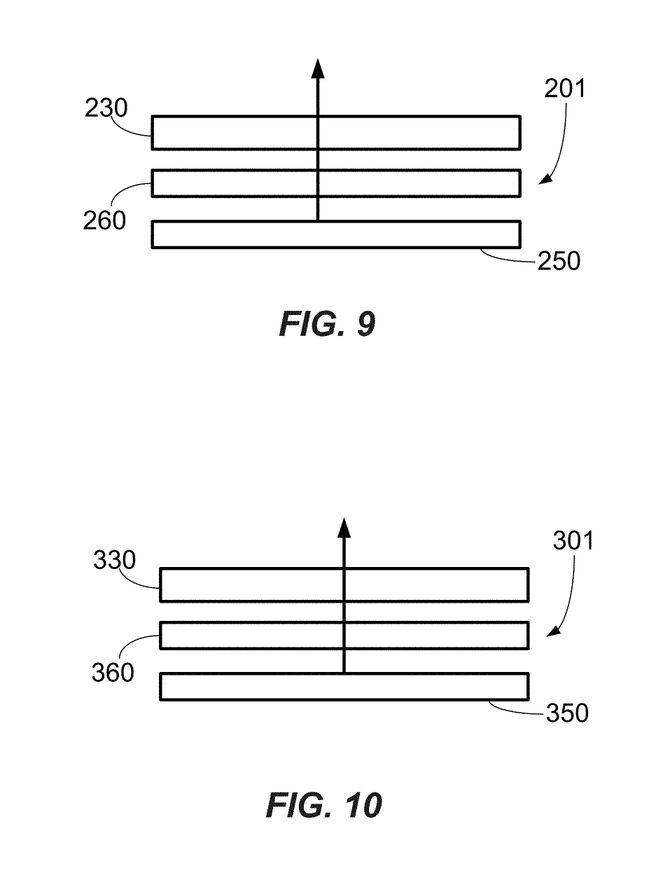

FIG. 9 is a schematic diagram of an illustrative OLED (organic light emitting diode) display 201. The retarder 260 (here a quarter wave plate) is disposed between the OLED panel 250 and a linear polarizer 230, the retarder 260 and the linear polarizer 230 forming a circular polarizer above the OLED panel 250. The retarder 260 is optically positioned between the OLED panel 250 and the linear polarizer 230. When two components are positioned or overlapped such that most of the light passing through a first component reaches a second component, then the first component is in optical communication with the second component. For example, most of the light that passes through the retarder 260 reaches the polarizer 230. Hence, the retarder 260 is in optical communication with polarizer 230. FIG. 10 is a schematic diagram of an illustrative liquid crystal display panel 301. The retarder 360 is disposed between the liquid crystal cell 350 and a polarizer 330 (such as a front polarizer). In some embodiments, the display assemblies 101, 102, 201, 301 include additional components or fewer components than illustrated in FIGS. 7-10. The arrow illustrates the general direction of light propagation from the display.

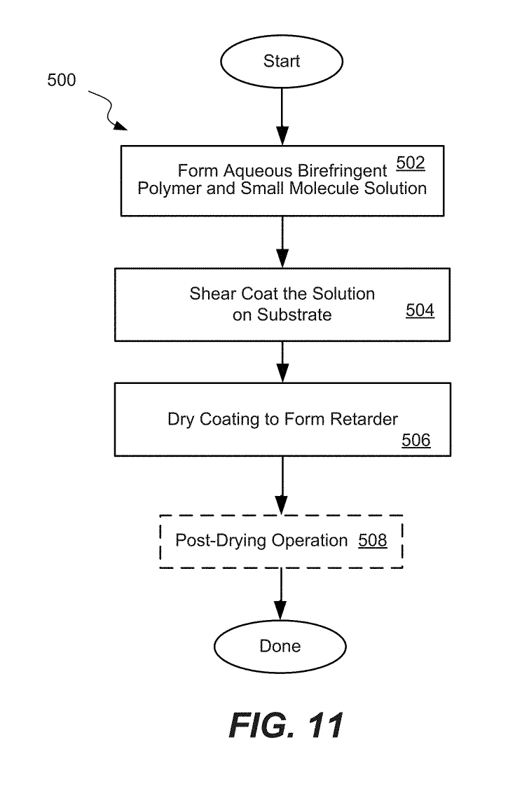

FIG. 11 illustrates a flow diagram 500 for forming the retarder described herein. The single layer retarder 60 can be formed by combining birefringent polymers and birefringent small molecules with water to form an aqueous mixture (step 502). Alternatively, these materials can be coated separately in layers as illustrated in FIG. 5 and FIG. 6. This aqueous mixture (or individual aqueous solutions of birefringent polymers or birefringent small molecules) is shear coated onto a substrate 10 to form an aligned aqueous layer (step 504). Then the aligned aqueous layer is dried to form a retarder 60 (step 506). Since the retarder 60 is formed of water-soluble material, it can be optionally stabilized or passivated by ion exchange (step 508, the stabilization or passivation is more generally referred to as a post-drying operation). The retarder 60 can be a thermally stable film that can be substantially transparent and substantially non-scattering.

The birefringent small molecule and birefringent polymer aqueous composition (or coating solution) may exhibit a lyotropic liquid crystal phase. The aqueous composition is at least 75 wt. %, or at least 80 wt. %, or at least 85 wt. %. In many embodiments, the coating solution is from 1 to 25 wt. %, or from 1 to 20 wt. %, or from 5 to 20 wt. %, or from 10 to 20 wt. % lyotropic liquid crystal material or birefringent small molecule and/or birefringent polymer. Shear coating allows the coating solution to be aligned according to the coating direction.

### Birefringent Polymers

The birefringent polymers can be made from various base materials having suitable optical birefringence and other properties, such as thermal resistance and light transmittance, and the like. The birefringent polymers are water-soluble and exhibit a liquid crystal phase in water. The birefringent polymers can be deposited, or coated onto a substrate via an aqueous solution. Once coated or deposited the aligned birefringent polymers can be stabilized or made less water-soluble by cross-linking or by ion exchange, generally termed “passivation.”

An exemplary birefringent lyotropic liquid crystal polymer is a birefringent polymer that may exhibit a lyotropic liquid crystal phase, where the polymer is of the following structure:

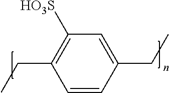

or a salt thereof, wherein n is an integer in a range from 25 to 10,000, or from 50 to 1000. This polymer is referred to as poly(monosulfo-p-xylene) or a salt thereof. The salt may be selected from an alkali metal, ammonium, quaternary ammonium, alkali earth metal, Al³⁺, La³⁺, Fe³⁺, Cr³⁺, Mn²⁺, Cu²⁺, Zn²⁺, Pb²⁺ and Sn²⁺.

This polymer in sodium salt form can be synthesized as follows:

300 ml of sulfuric acid was added to 212 g of p-xylene at 90° C. The reaction mass was stirred at 90-100° C. for 30 min then cooled to 20-25° C. and poured into a beaker with 500 g of mixture of water and ice. The resulting suspension was separated by filtration and the filter cake rinsed with cool (5° C.) solution of 300 ml of hydrochloric acid in 150 ml of water.

The material was vacuum dried at 50 mbar and 50° C. for 24 hrs. Yield of 2,5-dimethylbenzenesulfonic acid was 383 g (contained 15% water).

92.6 g of 2,5-dimethylbenzenesulfonic acid was added to 1700 ml of chloroform and the mixture was purged with argon gas. Then it was heated to boiling with a 500 W lamp placed right against the reaction flask so that stirred contents of the flask was well lit. 41 ml bromine in 210 ml of chloroform was added dropwise within 4-5 hrs to the agitated boiling mixture. Once all bromine had been added the light exposure with refluxing continued for an extra hour. 900 ml of chloroform was distilled and the reaction mass was allowed to cool overnight. Precipitated material was isolated by filtration, the filter cake was rinsed with 100 ml of chloroform, squeezed and recrystallized from 80 ml of acetonitrile. Yield of 2,5-bis(bromomethyl)benzenesulfonic acid was 21 g.

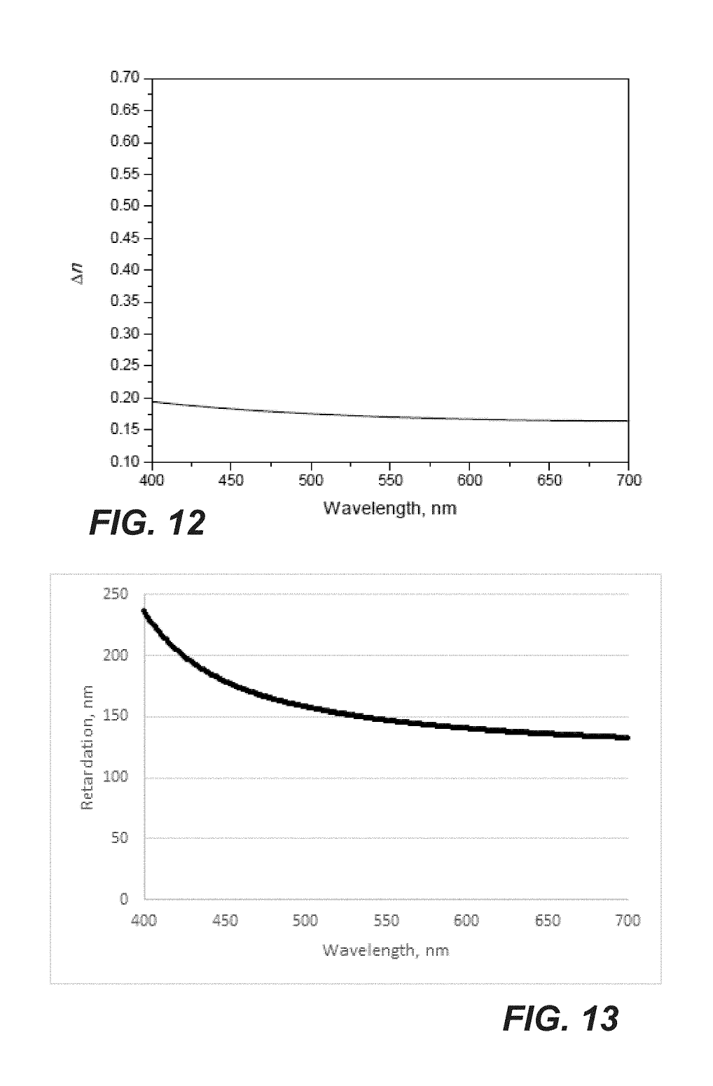

4.0 g of sodium borohydride in 20 ml of water was added to a stirred mixture of 340 mg of CuCl₂, 10.0 g of 2,5-bis(bromomethyl)benzenesulfonic acid, 10.4 g of sodium bromide, 45 ml of amyl alcohol and 160 ml of degassed water and the reaction mass was agitated for 10 min. Then the mixture was transferred to a 1-liter separatory funnel, 300 ml of water was added and after shaking the mixture was allowed to stand for an hour. The bottom layer was isolated, clarified by filtration and ultrafiltered using a polysulfone membrane with 10,000 molecular weight cut-off. Yield of polymer (Na salt) is 4.0 g (on dry basis). Δn aqueous solution of this material was coated onto a glass substrate with a Mayer rod and dried. The dispersion of in-plane retardation of this coating was graphed and is illustrated in FIG. 12.

### Birefringent Small Molecules

The birefringent small molecules can be made from various base materials having suitable optical birefringence and other properties, such as thermal resistance and light transmittance. The birefringent small molecules are water-soluble and exhibit a liquid crystal phase in water. The birefringent small molecules can be deposited, or coated onto a substrate via an aqueous solution. Once coated or deposited the aligned birefringent small molecules can be stabilized or made less water-soluble by ion exchange, generally termed “passivation.”

Exemplary birefringent small molecules that exhibit a lyotropic liquid crystal phase include molecules of the following structure:

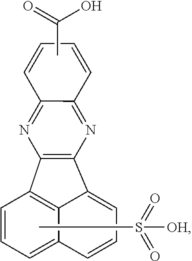

or a salt thereof.

The salt may be selected from an alkali metal, ammonium, quaternary ammonium, alkali earth metal, Al³⁺, La³⁺, Fe³⁺, Cr³⁺, Mn²⁺, Cu²⁺, Zn²⁺, Pb²⁺ and Sn²⁺. These birefringent small molecules, in free acid form, may be synthesized as follows:

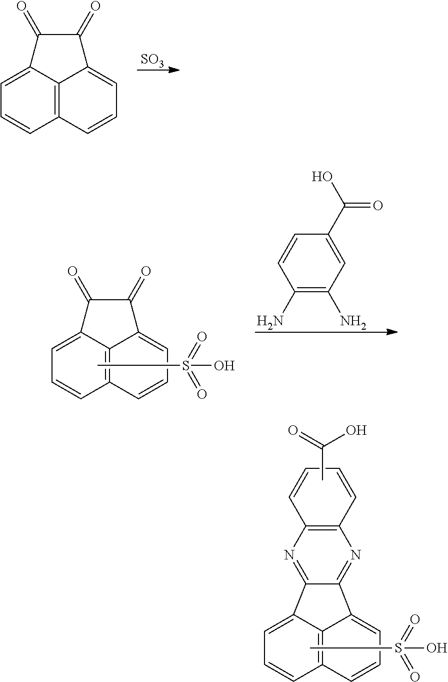

Step 1. 120 ml of 20% Oleum was placed into a 500 ml reaction vessel supplied with a mechanical stirrer, a thermometer and a desiccant tube. 40 g of Acenaphthenequinone was gradually added to Oleum with stirring at <40° C. within 90 min. Then the mixture was agitated for 24 hours, slowly diluted with 120 ml of water at <25° C. The precipitated material was isolated by filtration, washed with 40 ml of 70% H₂SO₄, squeezed between glass fiber sheets.

Step 2. 45 g of 3,4-Diaminobenzoic Acid was mixed with 1.2 L of Acetic acid and stirred at room temperature for 15 min and the solution clarified by filtration. The filtrate was mixed with 25 ml of 35% Hydrochloric acid. Resulting fine violet precipitate was isolated by filtration and dissolving in 400 ml of water.

Step 3. The filter-cake from Step 1 was mixed with 1.5 L of Acetic acid in a reaction vessel supplied with a thermometer and a mechanical stirrer, then the solution from Step 2 was poured in with stirring at room temperature and the mixture was agitated for 48 hours.

Step 4. The precipitated material from Step 3 was isolated by filtration. The filter cake was mixed with 1 L of Acetic acid and agitated overnight at room temperature. The product was isolated by filtration, washed with portions of Acetic acid until filtrate turned colorless and dried for 24 hours at 120° C. and 10 mm Hg. Yield was 30 g.

Objects and advantages of this disclosure are further illustrated by the following examples, but the particular materials and amounts thereof recited in these examples, as well as other conditions and details, should not be construed to unduly limit this disclosure.

### EXAMPLES

### Example 1—Small Molecule Retardation Measurement

Exemplary birefringent small molecules that exhibits a lyotropic liquid crystal phase include molecules of the following structure:

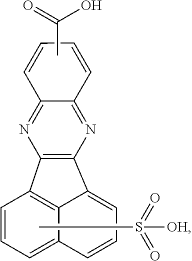

Cs salt form,
which was diluted to 16% solids by weight, in de-ionized (“DI”) water forming a coating solution. This coating solution was homogenized by stirring for 30 minutes with a magnetic stirrer at 40° C. Coating was done at room temperature (25° C.) on glass with a Mayer rod #4. The wet coating was dried with a gentle stream of air at 25° C. with air velocity 8 m/s along coating direction for 10 seconds. Dry thickness was measured to be 480 nm. The dispersion of in-plane retardation for these small molecules was graphed and is illustrated in FIG. 13. Retardation at 550 nm is R₀=147 nm. The curve was measured with the use of a polarimeter Axometrics Axoscan.

### Example 2. Small Molecule/Polymer Retardation Measurement

A small molecule/polymer mixture was prepared utilizing the small molecules of Example 1 and poly(monosulfo-p-xylene) sodium salt, described above. The polymer and small molecules were combined and mixed in 70:30 weight ratio (polymer:small molecule) at 18% solids. The mixture was homogenized by stirring for 60 minutes on a magnetic stirring hot plate at 70° C. Then the formulation was gradually cooled down to 40° C. Coating was done by Mayer rod #15 at a speed of 10 cm/s on a glass substrate. Freshly coated layer was dried with a gentle stream of air at 60° C. with air velocity 8 m/s along coating direction for 10 seconds.

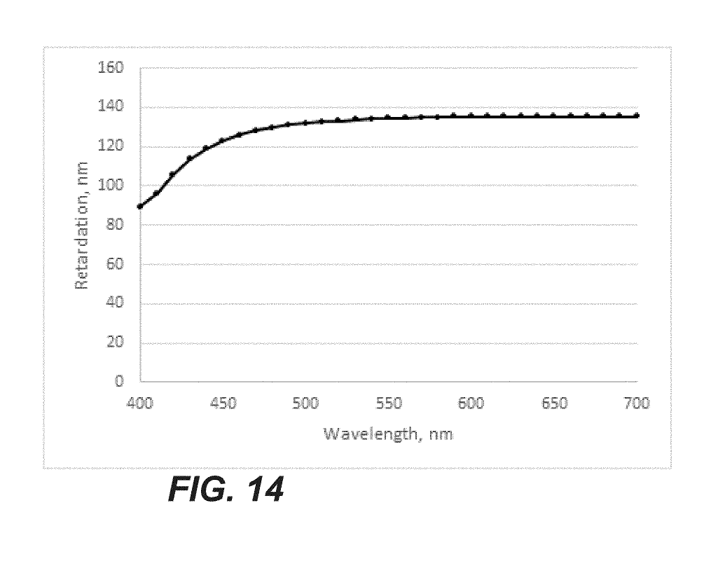

Dry thickness of the coating was measured to be 3.5 micrometers, and was examined with the use of a polarimeter Axometrics Axoscan. Retardation data was taken at normal incidence. The dispersion of in-plane retardation for this small molecule/polymer mixture was graphed and illustrated in FIG. 14. Retardation at 550 nm is R₀=134 nm. Retardation parameters R₀(450 nm)/R₀(550 nm)=0.9, R₀(650 nm)/R₀(550 nm)=1.02.

### Example 3. Small Molecule/Polymer Retardation Measurements

Five small molecule/polymer mixtures were prepared utilizing the small molecule of Example 1 and poly(monosulfo-p-xylene) sodium salt, described above. The polymer and small molecules were mixed in 5 different weight ratios 66:34, 68:32, 70:30, 72:28, and 74:26, all at 18% solids. The mixtures were homogenized by stirring for 60 minutes on a magnetic stirring hot plate at 70° C. Then formulations were gradually cooled down to 40° C. Coating was done by Mayer rod #15 at a speed of 10 cm/s on a glass substrate. Freshly coated layers were dried with a gentle stream of air at 60° C. with air velocity 8 m/s along coating direction for 10 seconds.

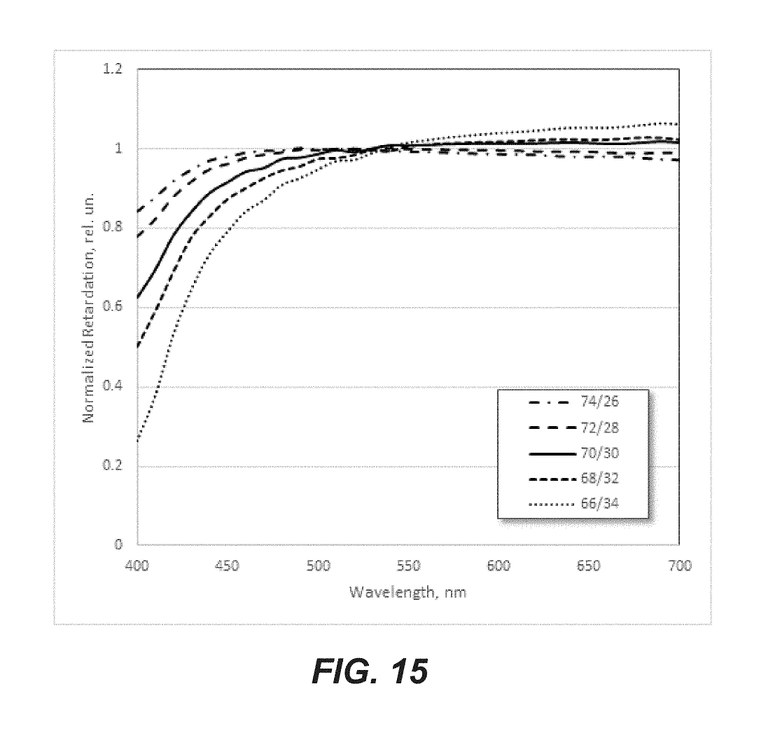

Dry thickness of the coatings was measured to be in a range from 3.0 to 3.7 micrometers, and was examined with the use of a polarimeter Axometrics Axoscan. Retardation data were taken at normal incidence. The dispersion of in-plane retardations for these small molecule/polymer mixtures was graphed and illustrated in FIG. 15.

Normalized retardation R₀(450 nm or 650 nm)/R₀(550 nm) at various Polymer/Small molecule ratios:

Retardation Parameters:

| Composition | 74:26 | 72:28 | 70:30 | 68:32 | 66:34 |
|---|---|---|---|---|---|
| R₀(450 nm)/R₀(550 nm) | 0.98 | 0.96 | 0.90 | 0.87 | 0.79 |
| R₀(650 nm)/R₀(550 nm) | 0.98 | 0.99 | 1.02 | 1.03 | 1.06 |

Ratios 74:26 and 72:28 represent primarily flat dispersion of retardation, whereas 70:30, 68:32, 66:34 represent reverse dispersion of retardation.

Thus, embodiments of LYOTROPIC LIQUID CRYSTAL POLYMER AND SMALL MOLECULE SOLUTIONS AND FILMS are disclosed.

All references and publications cited herein are expressly incorporated herein by reference in their entirety into this disclosure, except to the extent they may directly contradict this disclosure. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof. The disclosed embodiments are presented for purposes of illustration and not limitation.

What is claimed is:

1. A composition comprising:
an aqueous mixture comprising birefringent small molecules and a birefringent polymer, wherein the birefringent small molecules are of a structure: 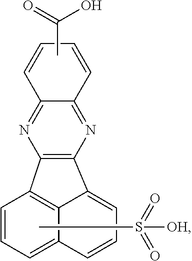
or a salt thereof.

2. The composition according to claim 1, wherein the birefringent polymer is of a structure: 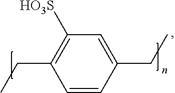
or a salt thereof,
wherein n is an integer in a range from 25 to 10,000.

3. The composition according to claim 2, wherein the birefringent polymer is present in the composition in a range from 50 to 90 wt. % dry solids.

4. The composition according to claim 3, wherein the birefringent polymer is present in the composition in a range from 60 to 80 wt. % dry solids.

5. The composition according to claim 1, wherein the birefringent small molecules are present in the composition in a range from 50 to 10 wt. % dry solids.

6. The composition according to claim 5, wherein the birefringent small molecules are present in the composition in a range from 40 to 20 wt. % dry solids.

7. The composition according to claim 2, wherein the birefringent small molecules are present in the composition in a range from 30 to 25 wt. % dry solids, and the birefringent polymer is present in the composition in a range from 70 to 75 wt. % dry solids.

8. The composition according to claim 2, wherein the birefringent small molecules are present in the composition in a range from 35 to 30 wt. % dry solids, and the birefringent polymer is present in the composition in a range from 65 to 70 wt. % dry solids.

9. A composition comprising:
an aqueous mixture comprising birefringent small molecules and a birefringent polymer, wherein the birefringent small molecules are of a structure: 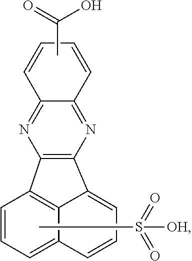
or a salt thereof; and
the birefringent polymer is of a structure: 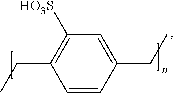
or salt thereof,
wherein n is an integer in a range from 25 to 10,000; and the birefringent polymer is present in the composition in a range from 50 to 90 wt. % dry solids, and the birefringent small molecules are present in the composition in a range from 50 to 10 wt. % dry solids.

10. The composition according to claim 9, wherein the birefringent small molecules are present in the composition in a range from 30 to 25 wt. % dry solids, and the birefringent polymer is present in the composition in a range from 70 to 75 wt. % dry solids.

11. The composition according to claim 9, wherein the birefringent small molecules are present in the composition in a range from 35 to 30 wt. % dry solids, and the birefringent polymer is present in the composition in a range from 65 to 70 wt. % dry solids.

12. A method of forming a retarder layer comprising:
shear coating the composition of claim 9 onto a substrate along a shear coating direction to form an aligned aqueous layer;
drying the aligned aqueous layer to form a retarder layer.

13. The method according to claim 12, wherein the drying step forms a retarder layer with a thickness in a range from 1 to 10 micrometers, or in a range from 1 to 5 micrometers.

14. A retarder layer comprising:
birefringent small molecules and a birefringent polymer, wherein the birefringent small molecules are of a structure: 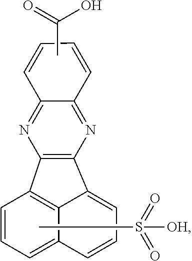
or a salt thereof; and
the birefringent polymer is of a structure: 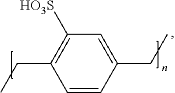
or a salt thereof,
wherein n is an integer in a range from 25 to 10,000.

15. The retarder layer according to claim 14, wherein the birefringent polymer is present in the retarder layer in a range from 50 to 90 wt. % dry solids, or from 60 to 80 wt. % dry solids, and the birefringent small molecules are present in the retarder layer in a range from 50 to 10 wt. % dry solids, or from 40 to 20 wt. % dry solids.

16. The retarder layer according to claim 14, wherein the birefringent small molecules are present in the retarder layer in a range from 30 to 25 wt. % dry solids, and the birefringent polymer is present in the retarder layer in a range from 70 to 75 wt. % dry solids.

17. The retarder layer according to claim 14, wherein the birefringent small molecules are present in the retarder layer in a range from 35 to 30 wt. % dry solids, and the birefringent polymer is present in the retarder layer in a range from 65 to 70 wt. % dry solids.

18. The retarder layer according to claim 14, wherein the retarder layer has a thickness in a range from 1 to 10 micrometers.

19. The retarder layer according to claim 18, wherein the retarder layer has a thickness in a range from 1 to 5 micrometers.

20. A circular polarizer comprising:
a linear polarizer; and
a retarder, according to claim 14, in optical communication with the linear polarizer.

21. A display comprising:
a display panel;
a polarizer; and
a retarder, according to claim 14, optically positioned between the display panel and the polarizer.

22. The display according to claim 21, wherein the display panel comprises a liquid crystal display panel.

23. The display according to claim 21, wherein the display panel comprises an organic light emitting diode display panel.

24. The display according to claim 21 wherein the polarizer and the retarder form a circular polarizer.
